(19) United States
(12) Patent Application Publication
(10) Pub. No.: US 2022/0093089 A1
(43) Pub. Date: Mar. 24, 2022

(54) MODEL CONSTRUCTING METHOD FOR AUDIO RECOGNITION

(71) Applicants: ASKEY COMPUTER CORP., New Taipei City (TW); ASKEY TECHNOLOGY (JIANGSU) LTD., Jiangsu Province (CN)

(72) Inventors: Chien-Fang Chen, Taoyuan City (TW); SETYA WIDYAWAN PRAKOSA, Jawa Timure (ID); Huan-Ruei Shiu, Taipei City (TW); Chien-Ming Lee, Taoyuan City (TW)

(73) Assignees: ASKEY COMPUTER CORP., NEW TAIPEI CITY (TW); ASKEY TECHNOLOGY (JIANGSU) LTD., Jiangsu Province (CN)

(21) Appl. No.: 17/197,050

(22) Filed: Mar. 10, 2021

(30) Foreign Application Priority Data
Sep. 21, 2020 (TW) 109132502

(51) Int. Cl. G10L 15/197; G10L 21/0232; G10L 25/51; G10L 15/06; G10L 15/22; G10L 15/02; G10L 15/05; G10L 15/30; G06N 3/08; G06N 3/04

(52) U.S. Cl. CPC G10L 15/197; G10L 21/0232; G10L 25/51; G10L 15/063; G10L 15/22; G10L 2015/0635; G10L 15/05; G10L 15/30; G06N 3/08; G06N 3/0445; G10L 15/02

(57) ABSTRACT

A model constructing method for audio recognition is provided. In the method, audio data is obtained. A predicted result of the audio data is determined by using the classification model which is trained by machine learning algorithm. The predicted result includes a label defined by the classification model. A prompt message is provided according to a loss level of the predicted result. The loss level is related to a difference between the predicted result and a corresponding actual result. The prompt message is used to query a correlation between the audio data and the label. The classification model is modified according to a confirmation response of the prompt message, and the confirmation response is related to a confirmation of the correlation between the audio data and the label. Accordingly, the labeling efficiency and predicting correctness can be improved.

### CROSS-REFERENCE TO RELATED APPLICATION

This application claims the priority benefit of Taiwan application serial no. 109132502, filed on Sep. 21, 2020. The entirety of the above-mentioned patent application is hereby incorporated by reference herein and made a part of this specification.

### BACKGROUND

### Field of the Disclosure

The disclosure relates to a machine learning technology, and particularly relates to a model construction method for audio recognition.

### Description of Related Art

Machine learning algorithms can analyze a large amount of data to infer the regularity of these data, thereby predicting unknown data. In recent years, machine learning has been widely used in the fields of image recognition, natural language processing, medical diagnosis, or voice recognition.

It is worth noting that for the voice recognition technology or other types of audio recognition technologies, during the training process of the model, the operator will label the type of sound content (for example, female's voice, baby's voice, alarm bell, etc.), so as to produce the correct output results in the training data, wherein the sound content is used as the input data in the training data. If the image is marked, the operator can recognize the object in a short time and provide the corresponding label. However, for the sound label, the operator may need to listen to a long sound file before marking, and the content of the sound file may be difficult to identify because of noise interference. It can be seen that the current training operations are quite inefficient for operators.

### SUMMARY OF THE DISCLOSURE

In view of this, the embodiments of the disclosure provide a model construction method for audio recognition, which provides simple inquiry prompts to facilitate operator marking.

The model construction method for audio recognition according to the embodiment of the disclosure includes (but is not limited to) the following steps: audio data is obtained. A predicted result of the audio data is determined by using the classification model which is trained by machine learning algorithm. The predicted result includes a label defined by the classification model. A prompt message is provided according to a loss level of the predicted result. The loss level is related to a difference between the predicted result and a corresponding actual result. The prompt message is used to query a correlation between the audio data and the label. The classification model is modified according to a confirmation response of the prompt message, and the confirmation response is related to a confirmation of the correlation between the audio data and the label.

Based on the above, the model construction method for audio recognition in the embodiment of the disclosure can determine the difference between the predicted result obtained by the trained classification model and the actual result, and provide a simple prompt message to the operator based on the difference. The operator can complete the marking by simply responding to this prompt message, and further modify the classification model accordingly, thereby improving the identification accuracy of the classification model and the marking efficiency of the operator.

In order to make the aforementioned features and advantages of the disclosure more comprehensible, embodiments accompanying figures are described in detail below.

### BRIEF DESCRIPTION OF THE DRAWINGS

FIG. 1 is a flowchart of a model construction method for audio recognition according to an embodiment of the disclosure.

FIG. 2 is a flowchart of audio processing according to an embodiment of the disclosure.

FIG. 3 is a flowchart of noise reduction according to an embodiment of the disclosure.

FIG. 4A is a waveform diagram illustrating an example of original audio data.

FIG. 4B is a waveform diagram illustrating an example of an intrinsic mode function (IMF).

FIG. 4C is a waveform diagram illustrating an example of denoising audio data.

FIG. 5 is a flowchart of audio segmentation according to an embodiment of the disclosure.

FIG. 6 is a flowchart of model training according to an embodiment of the disclosure.

FIG. 7 is a schematic diagram of a neural network according to an embodiment of the disclosure.

FIG. 8 is a flowchart of updating model according to an embodiment of the disclosure.

FIG. 9 is a schematic flowchart showing application of a smart doorbell according to an embodiment of the disclosure.

FIG. 10 is a block diagram of components of a server according to an embodiment of the disclosure.

### DESCRIPTION OF EMBODIMENTS

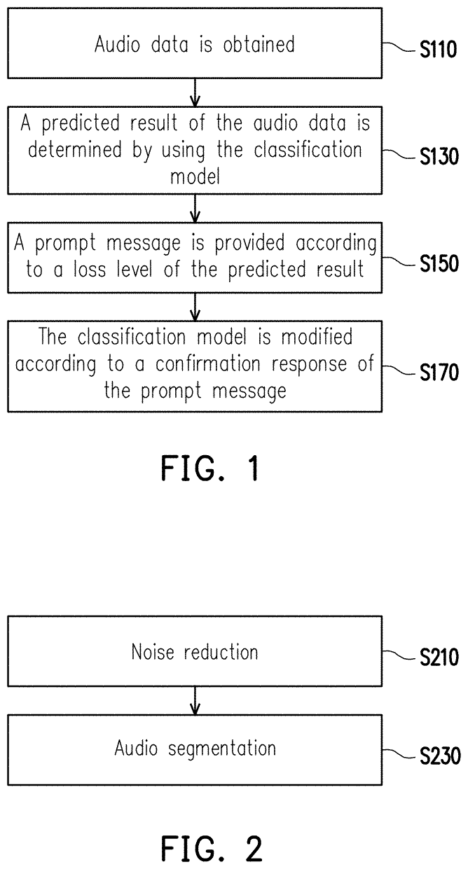

FIG. 1 is a flowchart of a model construction method for audio recognition according to an embodiment of the disclosure. Referring to FIG. 1, the server obtains audio data (step S110). Specifically, audio data refers to audio signals generated by receiving sound waves (e.g., human voice, ambient sound, machine operation sound, etc.) and converting the sound waves into analog or digital audio signals, or audio signals that are generated through setting the amplitude, frequency, tone, rhythm and/or melody of the sound by a processor (e.g., central processing unit, CPU), an application specific integrated circuit (ASIC), or a digital signal processor (DSP), etc. In other words, audio data can be generated through microphone recording or computer editing. For example, the baby's crying can be recorded through a smartphone, or the user can edit the soundtrack with music software on the computer. In an embodiment, the audio data can be downloaded via the network, transmitted in a wireless or wired manner (for example, through Bluetooth Low Energy (BLE), Wi-Fi, fiber-optic network, etc.), and then transmitted in a packet or stream mode in real-time or non-real-time, or accessed externally or through a built-in storage medium (for example, flash drives, discs, external hard drives, memory, etc.), thereby obtaining the audio data for use in subsequent construction of a model. For example, the audio data is stored in the cloud server, and the training server downloads the audio data via FTS.

In an embodiment, the audio data is obtained by audio processing the original audio data (the implementation mode and type of the audio data can be inferred from the audio data). FIG. 2 is a flowchart of audio processing according to an embodiment of the disclosure. Referring to FIG. 2, the server can reduce the noise component from the original audio data (step S210), and segment the audio data (step S230). In other words, the audio data can be obtained by performing noise reduction and/or audio segmentation on the original audio data. In some embodiments, the sequence of noise reduction and audio segmentation may be changed according to actual requirements.

There are many ways to reduce noise from audio. In an embodiment, the server can analyze the properties of the original audio data to determine the noise component (i.e., interference to the signal) in the original audio data. Audio-related properties are, for example, changes in amplitude, frequency, energy, or other physical properties, and noise components usually have specific properties.

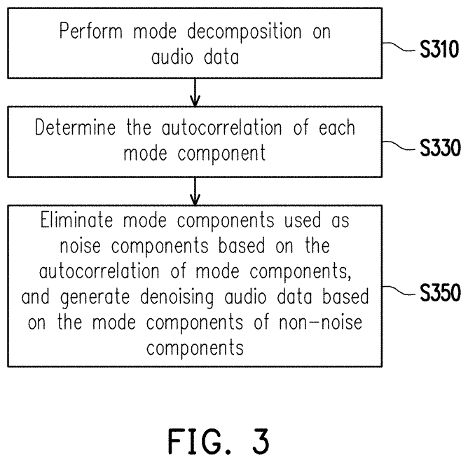

For example, FIG. 3 is a flowchart of noise reduction according to an embodiment of the disclosure. Please refer to FIG. 3, the properties include several intrinsic modal functions (IMF). The data that satisfies the following conditions can be referred to the intrinsic mode function: first, the sum of the number of local maxima and local minima is equal to the number of zero crossings or differs by one at most; second, at any point in time, the average of the upper envelope of the local maxima and the lower envelope of the local minima is close to zero. The server can decompose the original audio data (i.e., mode decomposition) (step S310) to generate several mode components (as fundamental signals) of the original audio data. Each mode component corresponds to an intrinsic mode function.

In an embodiment, the original audio data can be subjected to empirical mode decomposition (EMD) or other signal decomposition based on time-scale characteristics to obtain the corresponding intrinsic mode function components (i.e., mode component). The mode components include local characteristic signals of different time scales on the waveform of the original audio data in the time domain.

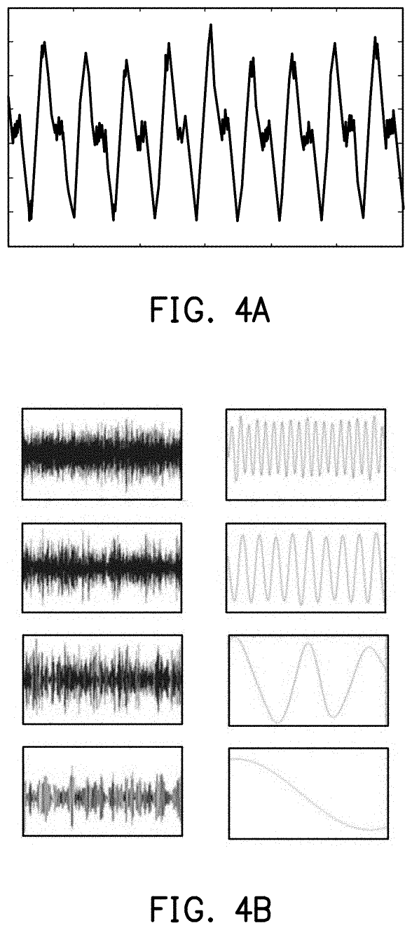

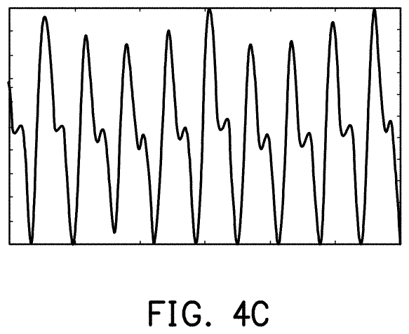

For example, FIG. 4A is a waveform diagram illustrating an example of original audio data, and FIG. 4B is a waveform diagram illustrating an example of an intrinsic mode function (IMF). Please refer to FIG. 4A and FIG. 4B. Through empirical mode decomposition, the waveform of FIG. 4A can be used to obtain seven different intrinsic mode functions and one residual component as shown in FIG. 4B.

It should be noted that, in some embodiments, each intrinsic mode function may be subjected to Hilbert-Huang Transform (HHT) to obtain the corresponding instantaneous frequency and/or amplitude.

The server may further determine the autocorrelation of each mode component (step S330). For example, Detrended Fluctuation Analysis (DFA) can be used to determine the statistical self-similar property (i.e., autocorrelation) of a signal, and the slope of each mode component can be obtained by linear fitting through the least square method. In another example, an autocorrelation operation is performed on each mode component.

The server can select one or more mode components as the noise component of the original audio data according to the autocorrelation of those mode components. Taking the slope obtained by DFA as an example, if the slope of the first mode component is less than the slope threshold (for example, 0.5 or other values), the first mode component is anti-correlated and is taken as noise component; if the slope of the second mode component is not less than the slope threshold, the second mode component is correlated and will not be regarded as a noise component.

In other embodiments, in other types of autocorrelation analysis, if the autocorrelation of the third mode component is the smallest, second smallest, or smaller, the third mode component may also be regarded as a noise component.

After determining the noise component, the server can reduce the noise component from the original audio data to generate audio data. Taking mode decomposition as an example, please refer to FIG. 3. The server can eliminate the mode component as the noise component based on the autocorrelation of the mode component, and generate denoising audio data based on the mode component of the non-noise component (step S350). In other words, the server reconstructs the signal based on the non-noise components other than the noise component in the original audio data, and generates denoising audio data accordingly. Specifically, the noise component can be removed or deleted.

FIG. 4C is a waveform diagram illustrating an example of denoising audio data. Please refer to FIG. 4A and FIG. 4C, compared with FIG. 4A, the waveform of FIG. 4C shows that the noise component has been eliminated.

It should be noted that the noise reduction of audio is not limited to the aforementioned mode and autocorrelation analysis, and other noise reduction techniques may also be applied to other embodiments. For example, a filter configured with a specific or variable threshold, or spectral subtraction, etc. may also be used.

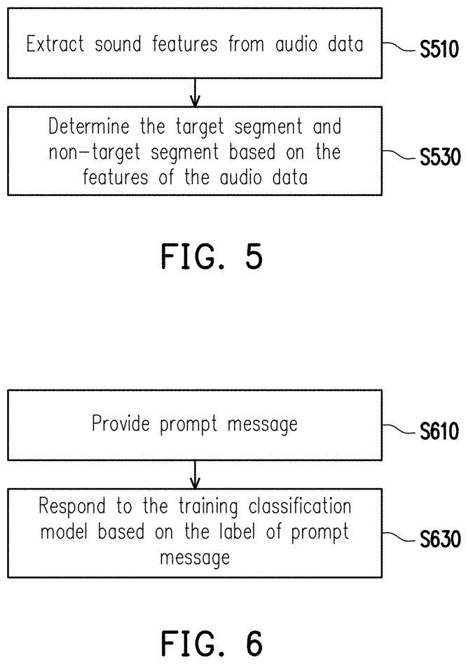

On the other hand, there are many audio segmentation methods for audio. FIG. 5 is a flowchart of audio segmentation according to an embodiment of the disclosure. Referring to FIG. 5, in an embodiment, the server may extract sound features from audio data (for example, original audio data or denoising audio data) (step S510). Specifically, the sound features may be a change in amplitude, frequency, timbre, energy, or at least one of the foregoing. For example, the sound feature is short time energy and/or zero crossing rate. The short time energy assumes that the sound signal changes slowly or even does not change in a short time (or window), and uses the energy within the short time as the representative feature of the sound signal, wherein different energy intervals correspond to different types of sounds, and can even be used to distinguish between voiced and silent segments. The zero crossing rate is related to the statistical quantity of the amplitude of the sound signal changing from a positive number to a negative number and/or from a negative number to a positive number, wherein the amount of the number corresponds to the frequency of the sound signal. In some embodiments, spectral flux, linear predictive coefficient (LPC), or band periodicity analysis can also be used to obtain sound features.

After obtaining the sound feature, the server can determine the target segment and non-target segment in the audio data according to the sound feature (step S530). Specifically, the target segment represents a sound segment of one or more designated sound types, and the non-target segment represents a sound segment of a type other than the aforementioned designated sound types. The sound type is, for example, music, ambient sound, voice, or silence. The corresponding value of the sound feature can correspond to a specific sound type. Taking the zero crossing rate as an example, the zero crossing rate of voice is about 0.15, the zero crossing rate of music is about 0.05, and the zero crossing rate of ambient sound changes dramatically. In addition, taking short time energy as an example, the energy of voice is about 0.15 to 0.3, the energy of music is about 0 to 0.15, and the energy of silence is 0. It should be noted that the value and segment adopted by different types of sound features for determining the types of sound may be different, and the foregoing values only serve as examples.

In an embodiment, it is assumed that the target segment is voice content (that is, the sound type is voice), and the non-target segment is not voice content (for example, ambient sound, or musical sound, etc.). The server can determine the end points of the target segment in the audio data according to the short time energy and zero crossing rate of the audio data. For example, in the audio data, the audio signal of which the zero crossing rate is lower than the zero crossing threshold is regarded as voice, the sound signal of which the energy is greater than the energy threshold is regarded as voice, and the sound segment of which the zero crossing rate is lower than the zero crossing threshold or the energy is greater than the energy threshold is regarded as the target segment. In addition, the beginning and end points of a target segment in the time domain are its boundary, and the sound segment outside the boundary may be a non-target segment. For example, the short time energy is utilized first for detection to roughly determine the end of sounding voice, and then zero crossing rate is utilized to detect the actual beginning and end of the voice segment.

In an embodiment, the server may retain the target segment for the original audio data or the denoising audio data and remove the non-target segment, so as to be used as the final audio data. In other words, a piece of sound data includes one or more pieces of target segments, and there are no non-target segments. Taking the target segment of the voice content as an example, if the audio data segmented by the audio is played, only human speech can be heard.

It should be noted that in other embodiments, either or both of steps S210 and S230 in FIG. 2 may also be omitted.

Referring to FIG. 1, the server may utilize the classification model to determine the predicted result of the audio data (step S130). Specifically, the classification model is trained based on machine learning algorithm. The machine learning algorithm is, for example, a basic neural network (NN), a recurrent neural network (RNN), a long short-term memory (LSTM) model or other algorithms related to audio recognition. The server can train the classification model in advance or directly obtain the initially trained classification model.

FIG. 6 is a flowchart of model training according to an embodiment of the disclosure. Referring to FIG. 6, for the pre-training, the server can provide an initial prompt message according to the target segment (step S610). This initial prompt message is used to request to label the target segment. In an embodiment, the server can play the target segment through a speaker, and provide visual or auditory message content through a display or speaker. For example, is it a crying sound? The operator can provide an initial confirmation response (i.e., a mark) to the initial prompt message. For example, the operator selects one of “Yes” or “No” through a keyboard, a mouse, or a touch panel. In another example, the server provides options (i.e., labels) such as crying, laughing, and screaming, and the operator selects one of the options.

After all the target segments are marked, the server can train the classification model according to the initial confirmation response of the initial prompt message (step S630). The initial confirmation response includes the label corresponding to the target segment. That is, the target segment serves as the input data in the training data, and the corresponding label serves as the output/predicted result in the training data.

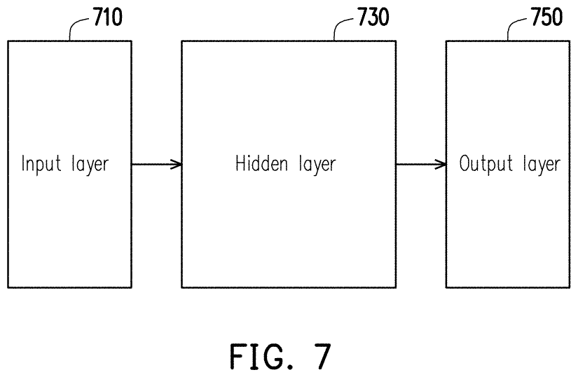

The server can use a machine learning algorithm preset or selected by the user. For example, FIG. 7 is a schematic diagram of a neural network according to an embodiment of the disclosure. Please refer to FIG. 7, the structure of the neural network mainly includes three parts: an input layer 710, a hidden layer 730, and an output layer 750. In the input layer 710, many neurons receive a large number of nonlinear input messages. In the hidden layer 730, many neurons and connections may form one or more layers, and each layer includes a linear combination and a nonlinear activation function. In some embodiments, for example, a recurrent neural network uses the output of one layer in the hidden layer 730 as the input of another layer. After the information is transmitted, analyzed, and/or weighed in the neuron connection, a predicted result can be formed in the output layer 750. The training for the classification model is to find the parameters (for example, weights, biases, etc.) and connections in the hidden layer 730.

After the classification model is trained, if the audio data is input to the classification model, the predicted result can be inferred. The predicted result includes one or more labels defined by the classification model. The labels are, for example, female's voices, male's voices, baby's voices, crying sound, laughter, voices of specific people, alarm bells, etc., and the labels can be changed according to the needs of the user. In some embodiments, the predicted result may further include predicting the probability of each label.

Referring to FIG. 1, the server may provide a prompt message according to the loss level of the predicted result (step S150). Specifically, the loss level is related to the difference between the predicted result and the corresponding actual result. For example, the loss level can be determined by using mean-square error (MSE), mean absolute error (MAE) or cross entropy. If the loss level does not exceed the loss threshold, the classification model can remain unchanged or does not need to be retrained. If the loss level exceeds the loss threshold, the classification model may need to be retrained or modified.

In the embodiment of the disclosure, the server will further provide prompt messages to the operator. The prompt message is provided to query the correlation between the audio data and the label. In an embodiment, the prompt message includes audio data and inquiry content, and the inquiry content queries whether the audio data belongs to a label (or whether it is related to a label). The server can play audio data through the speaker, and provide the inquiry content through the speaker or display. For example, the display presents the option of whether it is a baby's crying sound, and the operator simply needs to select one from the options of “Yes” and “No”. In addition, if the audio data has been processed by the audio as described in FIG. 2, the operator simply needs to listen to the target segment or the denoising sound, and the marking efficiency is bound to be improved.

It should be noted that, in some embodiments, the prompt message may also be an option presenting a query of multiple labels. For example, the message content may be “is it a baby's crying sound or adult's crying sound?”

The server can modify the classification model according to the confirmation response of the prompt message (step S170). Specifically, the confirmation response is related to a confirmation of the correlation between the audio data and the label. The correlation is, for example, belonging, not belonging, or a level of correlation. In an embodiment, the server may receive an input operation (for example, pressing, or clicking, etc.) of an operator through an input device (for example, a mouse, a keyboard, a touch panel, or a button, etc.). This input operation corresponds to the option of the inquiry content, and this option is that the audio data belongs to the label or the audio data does not belong to the label. For example, a prompt message is presented on the display and provides two options of “Yes” and “No”. After listening to the target segment, the operator can select the option of “Yes” through the button corresponding to “Yes”.

In other embodiments, the server may also generate a confirmation response through other voice recognition methods such as preset keyword recognition, preset acoustic feature comparison, and the like.

If the correlation is that the audio data belongs to the label in question or its correlation level is higher than the level threshold, it can be confirmed that the predicted result is correct (that is, the predicted result is equal to the actual result). On the other hand, if the correlation is that the information data does not belong to the label in question or its correlation level is lower than the level threshold, it can be confirmed that the predicted result is incorrect (that is, the predicted result is different from the actual result).

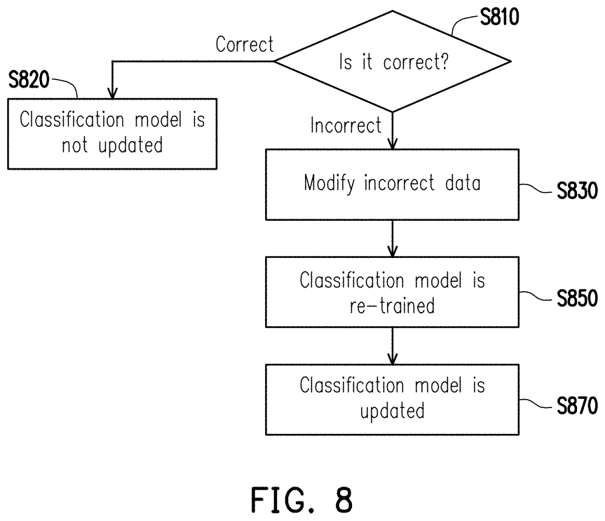

FIG. 8 is a flowchart of updating model according to an embodiment of the disclosure. Referring to FIG. 8, the server determines whether the predicted result is correct (step S810). If the predicted result is correct, it means that the prediction ability of the current classification model meets expectations, and the classification model does not need to be updated or modified (step S820). On the other hand, if the predicted result is incorrect (that is, the confirmation response believes that the label corresponding to the predicted result is wrong), the server can modify the incorrect data (step S830). For example, the option of “Yes” is amended into the option of “No”. Then, the server can use the modified data as training data and retrain the classification model (step S850). In some embodiments, if the confirmation response has designated a specific label, the server may use the label and audio data corresponding to the confirmation response as the training data of the classification model, and retrain the classification model accordingly. After retraining, the server can update the classification model (step S870), for example, by replacing the existing stored classification model with the retrained classification model.

It can be seen that the embodiment of the disclosure evaluates whether the prediction ability of the classification model meets expectations or whether it needs to be modified through two stages, namely loss level and confirmation response, thereby improving training efficiency and prediction accuracy.

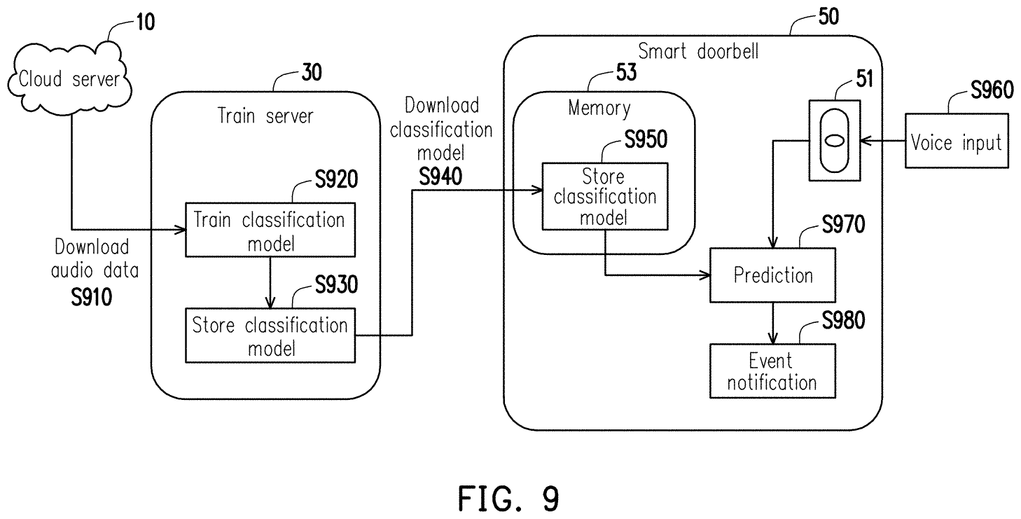

In addition, the server can also provide the classification model for other devices to use. For example, FIG. 9 is a schematic flowchart showing application of a smart doorbell 50 according to an embodiment of the disclosure. Referring to FIG. 9, the training server 30 downloads audio data from the cloud server 10 (step S910). The training server 30 may train the classification model (step S920), and store the trained classification model (step S930). The training server 30 can set up a data-providing platform (for example, as a file transfer protocol (FTS) server or a website server), and can provide a classification model to other devices through transmission of the network. Taking the smart doorbell 50 as an example, the smart doorbell 50 can download the classification model through the FTS (step S940), and store the classification model in its own memory 53 for subsequent use (step S950). On the other hand, the smart doorbell 50 can collect external sound through the microphone 51 and receive voice input (step S960). The voice input is, for example, human speech, human shouting, or human crying, etc. Alternatively, the smart doorbell 50 can collect sound information from other remote devices through Internet of Things (IoT) wireless technology (for example, LE, Zigbee, or Z-wave, etc.), and the sound information can be transmitted to the smart doorbell 50 through real-time streaming in a wireless manner. After receiving the sound information, the smart doorbell 50 can parse the sound information and use it as voice input. The smart doorbell 50 can load the classification model obtained through the network from its memory 53 to recognize the received voice input and determine the predicted/recognition result (step S970). The smart doorbell 50 may further provide an event notification according to the recognition result of the voice input (step S980). For example, if the recognition result is a call from a male host, the smart doorbell 50 will send out an auditory event notification in the form of music. In another example, if the recognition result is a call from a delivery man or other non-family member, the smart doorbell 50 presents a visual event notification in the form of an image at the front door.

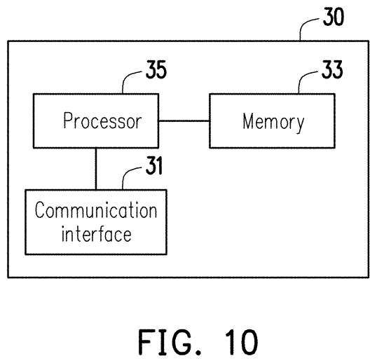

FIG. 10 is a block diagram of components of a training server 30 according to an embodiment of the disclosure. Please refer to FIG. 10, the training server 30 may be a server that implements the embodiments described in FIG. 1, FIG. 2, FIG. 3, FIG. 5, FIG. 6 and FIG. 8, and may be computing devices such as a workstation, a personal computer, a smart phone, or a tablet PC. The training server 30 includes (but is not limited to) a communication interface 31, a memory 33, and a processor 35.

The communication interface 31 can support optical-fiber networks, Ethernet networks, or wired networks such as cables, and may also support Wi-Fi, mobile networks, and Bluetooth (for example, BLE, fifth-generation, or later generation), Zigbee, Z-Wave and other wireless networks. In an embodiment, the communication interface 31 is used to transmit or receive data, for example, receive audio data, or transmit the classification model.

The memory 33 can be any type of fixed or removable random access memory (RAM), read-only memory (ROM), flash memory or the like, and are used to record program codes, software modules, audio data, classification models and related parameters thereof, and other data or files.

The processor 35 is coupled to the communication interface 31 and the storage 33. The processor 35 may be a central processing unit (CPU) or other programmable general-purpose or specific-purpose microprocessor, digital signal processing (DSP), programmable controller, application-specific integrated circuit (ASIC) or other similar components or a combination of the above components. In the embodiment of the disclosure, the processor 35 is configured to execute all or part of the operations of the server 30, such as training the classification model, audio processing, or data modification.

In summary, in the model construction method for audio recognition in the embodiment of the disclosure, a prompt message is provided according to the loss level difference between the predicted result obtained by the classification model and the actual result, and the classification model is modified according to the corresponding confirmation response. For the operator, the marking can be easily completed by simply responding to the prompt message. In addition, the original audio data can be processed by noise reduction and audio segmentation to make it easy for the operators to listen to. In this way, the recognition accuracy of the classification model and the marking efficiency of the operator can be improved.

Although the present disclosure has been described in detail with reference to the foregoing embodiments, those of ordinary skill in the art should understand that it is still possible to modify the technical solutions described in the foregoing embodiments, or equivalently replace some or all of the technical features; these modifications or replacements do not make the nature of the corresponding technical solutions deviate from the scope of the technical solutions in the embodiments of the present disclosure.

What is claimed is:

1. A model construction method for audio recognition, comprising:
obtaining an audio data;
determining a predicted result of the audio data by using a classification model, wherein the classification model is trained based on a machine learning algorithm, and the predicted result comprises a label defined by the classification model;
providing a prompt message according to a loss level of the predicted result, wherein the loss level is related to a difference between the predicted result and a corresponding actual result, and the prompt message is provided to query a correlation between the audio data and the label; and
modifying the classification model according to a confirmation response of the prompt message, wherein the confirmation response is related to a confirmation of the correlation between the audio data and the label.

2. The model construction method for audio recognition according to claim 1, wherein the prompt message comprises the audio data and an inquiry content, the inquiry content is to query whether the audio data belongs to the label, and the steps of providing the prompt message comprises:
playing the audio data and providing the inquiry content.

3. The model construction method for audio recognition according to claim 2, wherein the step of modifying the classification model according to the confirmation response of the prompt message comprises:
receiving an input operation, wherein the input operation corresponds to an option of the inquiry content, and the option is that the audio data belongs to the label or the audio data does not belong to the label; and
determining the confirmation response based on the input operation.

4. The model construction method for audio recognition according to claim 1, wherein the step of modifying the classification model according to the confirmation response of the prompt message comprises:
adopting a label and the audio data corresponding to the confirmation response as training data of the classification model, and the classification model is retrained accordingly.

5. The model construction method for audio recognition according to claim 1, wherein the step of obtaining the audio data comprises:
analyzing properties of an original audio data to determine a noise component of the original audio data; and
eliminating the noise component from the original audio data to generate the audio data.

6. The model construction method for audio recognition according to claim 5, wherein the properties comprise a plurality of intrinsic mode functions (IMF), and the step of determining the noise component of the audio data comprises:
decomposing the original audio data to generate a plurality of mode components of the original audio data, wherein each of the mode components corresponds to an intrinsic mode function;
determining an autocorrelation of each of the mode components; and
selecting one of the mode components as the noise component according to the autocorrelation of the mode components.

7. The model construction method for audio recognition according to claim 1, wherein the step of obtaining the audio data comprises:
extracting a sound feature from the audio data;
determining a target segment and a non-target segment in the audio data according to the sound feature; and
retaining the target segment, and removing the non-target segment.

8. The model construction method for audio recognition according to claim 5, wherein the step of obtaining the audio data comprises:
extracting a sound feature from the audio data;
determining a target segment and a non-target segment in the audio data according to the sound feature; and
retaining the target segment, and removing the non-target segment.

9. The model construction method for audio recognition according to claim 7, wherein the target segment is a voice content, the non-target segment is not the voice content, the voice features comprises a short time energy and a zero crossing rate, and the step of extracting the sound feature from the audio data comprises:
determining two end points of the target segment in the audio data according to the short time energy and the zero crossing rate of the audio data, wherein the two end points are related to a boundary of the target segment in a time domain.

10. The model construction method for audio recognition according to claim 7, further comprising:
providing a second prompt message according to the target segment, wherein the second prompt message is provided to request the label be assigned to the target segment; and
training the classification model according to a second confirmation response of the second prompt message, wherein the second confirmation response comprises the label corresponding to the target segment.

11. The model construction method for audio recognition according to claim 1, further comprising:
providing the classification model that is transmitted through a network;
loading the classification model obtained through the network to recognize a voice input; and
providing an event notification based on a recognition result of the voice input.
